(19) United States
(12) Patent Application Publication
(10) Pub. No.: US 2020/0023297 A1
(43) Pub. Date: Jan. 23, 2020

(54) METHOD FOR MANUFACTURING A FILTER MEDIUM, AND FILTER MEDIUM

(71) Applicant: Mahle International GmbH, Stuttgart (DE)

(72) Inventors: Ralf Disson, Leutenbach (DE); Hartmut Harr, Waldenbuch (DE); Hannes Lay, Nuertingen (DE); Bernd Neubauer, Rudersberg (DE); Birgit Renz, Marbach (DE); Markus Steppe, Malmsheim (DE)

(21) Appl. No.: 16/305,881

(22) PCT Filed: May 30, 2017
(86) PCT No.: PCT/EP2017/063002

§ 371 Date: Sep. 30, 2019

(30) Foreign Application Priority Data
May 31, 2016 (DE) 102016209482.3

(51) Int. Cl. B01D 39/16; B01D 39/18; B32B 5/02; B32B 29/02; B32B 7/05; B32B 37/00; B32B 37/04; B32B 37/06; B32B 37/10; B32B 37/20

(52) U.S. Cl. CPC B01D 39/163; B32B 2317/12; B32B 5/02; B32B 29/02; B32B 7/05; B32B 37/0076; B32B 37/04; B32B 37/06; B32B 37/10; B32B 37/203; B01D 2239/025; B01D 2239/0668; B01D 2239/10; B32B 2250/02; B32B 2262/02; B32B 2307/724; B32B 2307/726; B01D 39/18

(57) ABSTRACT

A method for manufacturing a filter medium comprising at least two filter plies according to which at least a first filter ply has a plurality of thermoplastically deformable fibres, by means of which the at least two filter plies are joined to each other in some areas. The method comprises forming, by means of at least two rolls of a pressing tool, at least one additional joining region configured in a web-like manner in the at least two filter plies in which the at least two filter plies are joined to each other.

### CROSS-REFERENCE TO RELATED APPLICATION

This application claims priority to German Patent Application No. DE 10 2016 209 482.3, filed on May 31, 2016, and International Patent Application No. PCT/EP2017/063002, filed on May 30, 2017, both of which are hereby incorporated by reference in their entirety.

### TECHNICAL FIELD

The invention relates to a method for manufacturing a filter medium and a filter medium which is manufactured by means of this method.

### BACKGROUND

Filter systems for the filtering of fresh air and of fluids, such as for example oil, fuel or coolant, are required for a low-wear long-term operation of an internal combustion engine. In order to prevent a contamination of said media with dirt particles or similar, a suitable filter medium is necessary. Modern filter media generally consist of several filter plies and have spacer elements, also known to the relevant specialist in the art as so-called “cams”. Said spacer elements ensure that the filter plies are arranged in some areas at a distance from one another. In this way, an improved filter effect is achieved. In the case of applied fluid pressure, the said spacer elements in addition prevent an undesired block formation of the filter folds formed in the filter medium.

A variety of manufacturing methods exist for the manufacture of said filter media. Typically, two or more filter plies are joined to each other for the manufacture of said filter medium. Such conventional filter media with two or more filter plies are either joined to each other directly in the manufacturing process—for example the manufacture of several “headboxes” in the so-called “air-laid” or “wet-laid” process is to be mentioned—or in a downstream or respectively offline method.

The stamping of spacer elements, for instance in the form of a groove structure, into filter media which have already been joined to each other takes place either in a further process step or, alternatively thereto, after the joining process and immediately before the folding of the filter medium. Also, a subsequent introduction of said spacer elements, therefore after folding of the filter medium, for instance by injecting around or inserting of an additional component, for instance a comb, is known from the prior art.

However, all the named methods are associated with a relatively high technical effort, which has a disadvantageous effect on the manufacturing costs of the filter medium.

Against this background, DE 10 2006 062 189 B4 discloses a method for the manufacture of a 3-dimenionsal, material web structured in a faceted manner. In the method, a material web is configured in a primary manufacturing step with a multi-dimensional structuring and is provided with depressions and folds. Subsequently, the depressions are partially supported on their concave side by support elements respectively converging to a stand point. Thereafter, in a further structuring step, a pressure medium is pressed against the concave side of the depressions, and an active medium presses against the convex side of the depressions. The surface quality of the material web, which is structured in a three-dimensionally faceted manner, is maintained in this way.

### SUMMARY

It is an object of the present invention to indicate new ways in a manufacturing method for manufacturing a filter medium having at least two filter plies.

This problem is solved by the subject matter of the independent claims. Preferred embodiments are the subject matter of the dependent claims.

Accordingly, a central idea of the invention is to join at least two filter plies to each other in some areas by means of thermoplastically deformable fibres in at least a first filter ply. This permits a considerably simplified manufacture of the filter medium compared to conventional methods. The terms “thermoplastic” and “thermoplastically deformable” are used here in an equivalent manner.

In a preferred embodiment, the at least two filter plies have respectively at least one portion in which they are not joined to each other by means of the thermoplastic fibres. This permits a particularly flexible fastening of the at least two filter plies to each other.

In another preferred embodiment, at least a first filter ply is provided for carrying out the method, which ply has a plurality of thermoplastic fibres which are warmed before and/or during the joining to each other. The thermoplastic fibres are softened and/or at least melted by the warming. In this way, a materially bonded connection in the form of an adhesive connection can be produced in a simple manner between the first filter ply in the region of the thermoplastic fibres and the second filter plies.

In an advantageous further development, the fibres provided in the first filter ply are configured as thermoplastic fibres which can be deformed by means of a heating device. The use of a heating device enables a particularly homogeneous joining process.

Expediently, said heating device can be part of a joining tool for joining the two filter plies to each other. This variant permits a warming/heating of the fibres of the first filter ply before and/or during the joining to each other by means of the joining tool. In this way, a particularly good materially bonded connection or respectively adhesive connection is achieved between the fibres of the first filter ply and the at least one further filter ply.

In an advantageous further development, both filter plies, therefore both joining partners, have thermoplastic fibres. In this way, a particularly stable connection can be produced between the two filter plies.

In an advantageous further development, at least one filter ply can have additional, non-thermoplastic fibres. These fibres remain untouched by the actual joining process and can therefore provide for an improved stability of the at least one filter ply both before and also after the joining process.

In an advantageous further development, a pressing tool is used as joining tool for joining the at least two filter plies to each other. By means of such a pressing tool, which can comprise rollers acting as compression rolls, it is possible to press the at least two filter plies to each other. In this way, the at least one first filter ply is connected in the region of its joining zones with the at least one further filter ply. In zones of the first filter ply complementary to the joining zones, the first filter ply, on the other hand, only lies on the second filter ply or respectively, in a preferred embodiment, can also be arranged spaced apart from the second filter ply.

In a further advantageous further development, the joining tool is configured such that in the region between the fibres a predetermined distance geometry is produced during the joining to each other. The introduction of a special distance geometry in an additional method step can be dispensed with in this variant.

In another advantageous further development, the at least two filter plies are joined to each other in a method step and in the same method step are arranged at a distance from one another in some areas. This provision permits a considerably simplified manufacture of the filter medium with two or more filter plies, compared to conventional methods.

Particularly preferably, at least one additional joining region, preferably configured in a web-like manner, can be formed in the at least two filter plies by means of two further, additional rolls of the pressing tool. In this additional joining region, the at least two filter plies are joined to each other. Such an additional joining region, configured in a web-like manner, is preferably used to form a filter fold in a further method step.

In another advantageous further development, the distance geometry produced by means of the joining tool is a sinusoidal or trapezoidal geometry, or, alternatively thereto, a groove-like geometry. All the named geometries have in common the fact that they distinctly improve the filter effect of the filter medium.

In another preferred embodiment, the joining tool comprises an ultrasound source, so that the at least two filter plies are joined to each other by the action of ultrasound. The use of an ultrasound source for carrying out the method leads to the production of a particularly durable adhesive connection between the filter layers.

In a further preferred embodiment, at least a second filter ply without thermoplastic fibres is provided, which has cellulose, in particular paper, and/or nanofibres as ply material. Such filter plies without thermoplastic fibres, therefore fibres which are meltable by warming/heating, which are based on the previously mentioned material systems, are able to be joined in a particularly simple manner to the fibres of the first filter ply, or respectively are able to be connected therewith in a materially bonded manner, preferably with an adhesive connection.

The invention furthermore relates to a filter medium which has at least two filter plies, which are preferably manufactured by means of the previously presented method. The advantages previously explained in connection with the method according to the invention are therefore also transferred to the filter medium according to the invention.

In a preferred embodiment, the two filter plies have respectively at least one portion in which they are not joined to each other by means of the thermoplastic fibres. This permits a particularly flexible fastening of the at least two filter plies to each other.

Expediently, the at least two filter plies, which in the at least one portion are not joined to each other by means of the thermoplastically deformable fibres, can have a predetermined distance geometry. In an advantageous further development, this predetermined distance geometry is a sinusoidal or trapezoidal or groove-like or cam-like geometry.

In a further preferred embodiment, the filter medium is manufactured using the method according to the previously presented method. The previously explained advantages of the manufacturing method are therefore also transferred to the filter medium according to the invention.

Further important features and advantages of the invention will emerge from the subclaims, from the drawings and from the associated figure description with the aid of the drawings.

It shall be understood that the features named above and to be explained further below, are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively diagrammatically:

FIG. 1 shows an illustration explaining the method according to the invention,

FIG. 2 shows a first example of a filter medium manufactured by means of the method according to FIG. 1,

FIG. 3 shows a second example of a filter medium manufactured by means of the method according to FIG. 1,

FIG. 4 shows a third example of a filter medium manufactured by means of the method according to FIG. 1,

FIG. 5 shows a fourth example of a filter medium manufactured by means of the method according to FIG. 1.

### DETAILED DESCRIPTION

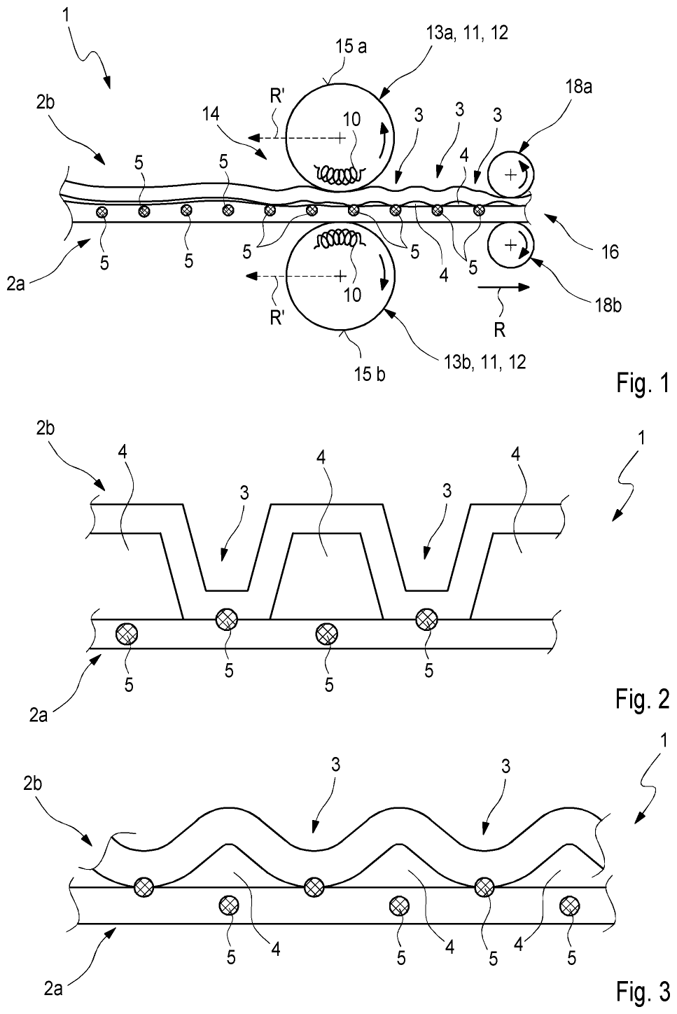

In the following, by means of the illustration of FIG. 1, the carrying out of the method according to the invention is explained by way of example. FIG. 1 shows a first filter ply 2a and a second filter ply 2b, from which a filter medium 1 according to the invention is manufactured by carrying out the method according to the invention. It is clear that in variants of the example, filter media 1 with more than only 2 filter plies 2a, 2b can be manufactured.

As FIG. 1 shows, the first filter ply 2a has a plurality of thermoplastic fibres 5. These thermoplastic fibres 5 are therefore fibres which can be plastically deformed by means of a suitable heating device 10 through warming. The second filter ply 2b, on the other hand, does not have any thermoplastic fibres and can have cellulose, in particular paper, and/or nanofibres as ply material. Also, the first filter ply 2a can have cellulose, in particular paper, and/or nanofibres as ply material, in addition to the fibres 5. In a variant, the second filter ply 2b can also have fibres 5 in an analogous manner to the filter ply 2a (not shown in FIG. 1).

The method described here is distinguished in that the two filter plies 2a, 2b are joined to each other in a single, common method step, and in so doing are arranged in some areas at a distance from one another. In other words, the joining of the two filter plies 2a, 2b to each other takes place in several, shared joining portions 3, which are established by the position of the joining roller/roll webs.

By comparison, the two filter plies 2a 2b are arranged at a distance from one another in regions 4 between adjacent joining zones 3. For the joining of the two filter plies 2a, 2b to each other, the majority of the fibres 5 in the first filter ply 2a are warmed by means of the heating device 10. Such a warming is accompanied by a softening and/or at least partial melting of the fibres 5 in the first filter ply 2a. In this way, the first filter ply 2a can be joined to the second filter plies 2b in the region of the fibres 5, therefore in the region of the joining zones 3 with the formation of an adhesive connection, therefore in a materially bonded manner.

The joining of the two filter plies 2a, 2b to each other takes place with the aid of a joining tool 11, which in the example of FIG. 1 is configured as a pressing tool 12 and comprises two rollers 13a, 13b. By means of the pressing tool 12, the two filter plies 2a, 2b are pressed against one another such that the first filter ply 2a, in the region of its thermoplastic fibres 5, is pressed with the second filter ply 2b and therefore joined to each other in a materially bonded manner. In regions 4 between the fibres 5 of the first filter ply 2a, on the other hand, no materially bonded connection is formed.

For the joining to each other or respectively bonding with one another, the two filter plies 2a, 2b are firstly arranged on one another and are directed by means of a rotational movement of the two rollers 13a, 13b along a joining direction R through an intermediate space 14 formed between the two rollers 13a, 13b. In said intermediate space 14, the actual joining to each other takes place by means of pressing.

In a variant of the example, it is also conceivable to roll the two rollers 13a, 13b contrary to the joining direction R along a rolling direction R′.

The heating device 10 can be integrated into the two rollers 13a, 13b of the pressing tool 12. The heating device 10 can be constructed as an electrical heating device, which is indicated diagrammatically in FIG. 1. In this case, the heating device 10 is therefore part of the joining tool 11. Alternatively, however, the provision of a separate heating device in the form of a suitable heating oven is conceivable, which is arranged immediately adjacent to the joining tool 11 (not shown). Furthermore, an irradiation of the two filter plies 2a, 2b by means of heat radiation is conceivable, so that these are warmed as desired before joining to each other. In this case, the heating device 10 is constructed as a heat radiation source, which is also arranged immediately adjacent to the joining tool 11 (not shown). Preferably therefore the heating device 11, irrespective of its actual technical form of embodiment, is integrated into the joining tool 11 and is therefore part of the joining tool 11. The close provision of the heating device 10 directly at the joining tool 11, in the example of FIG. 1 therefore at the rollers 13a, 13b of the pressing tool 12, enables a particularly effective warming of the fibres 5 of the first or second filter ply 2a, 2b. In particular, it is ensured that also directly during the joining process the necessary increased temperature for the joining to each other or respectively bonding is provided in the region of the joining zones 3.

The rollers 13a, 13b of the pressing tool 12 or respectively of the joining tool 11 are configured such that in the produced filter medium 1 with the at least two filter plies 2a, 2b in the regions 4 between the fibres 5 a predetermined distance geometry is produced during the joining to each other.

This can be, for example, a trapezoidal geometry, illustrated in FIG. 2, or a sinusoidal geometry, illustrated in FIG. 3. The desired geometry can be established through corresponding configuration of the exterior circumferential sides 15a, 15b of the two rollers 13a, 13b. In addition to the previously mentioned sinusoidal or respectively trapezoidal configuration, other geometries are also conceivable.

By means of two further, additional rollers 18a, 18b at least one additional joining region 16, preferably configured in a web-like manner, can be formed in the at least two filter plies 2a, 2b. In a preferred embodiment, the web-like additional configuration region can also be integrated in the roller 15b. In the additional joining region 16, a fold (not shown) of the filter medium 1, can be formed later in a further optional method step.

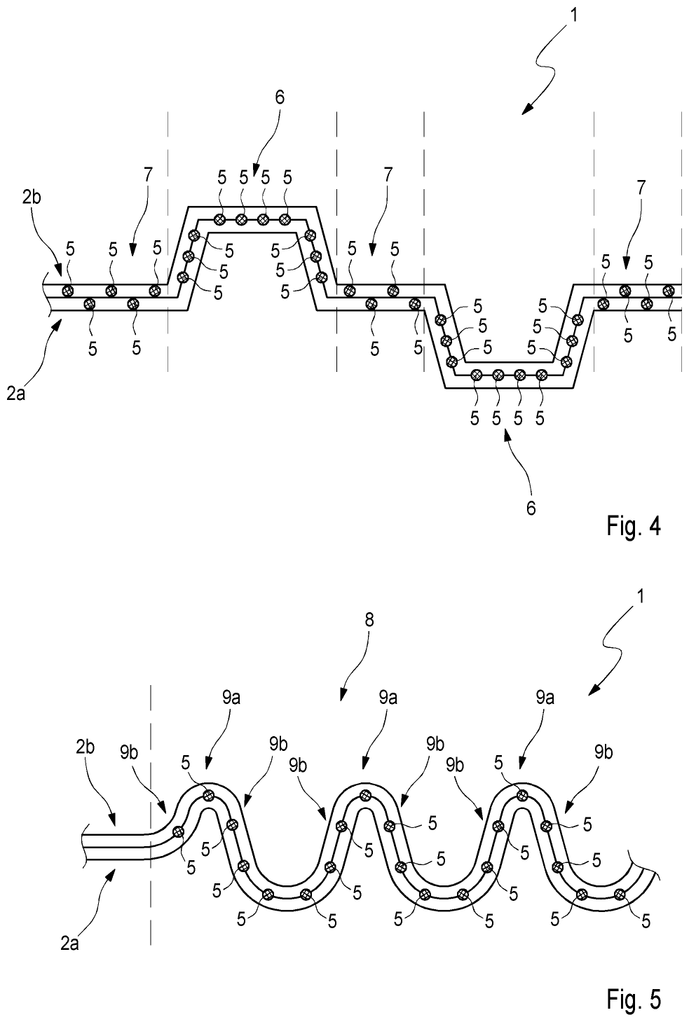

FIG. 4 shows as a further variant two filter plies 2a, 2b with a cam-like geometry, so that a plurality of cams 6—only two such cams 6 are shown by way of example in the example of FIG. 4—are arranged at a distance from one another. In the region of the cams 6 the two filter plies 2a, 2b lie against one another and are joined to each other in the region of the cams 6 by means of the thermoplastic fibres 5. By comparison, the filter plies 2a 2b in portions 7 are not connected to each other between two cams 6, but rather only lie against one another. The joining connection in the region of the cams 6 can take place in a planar manner over the entire respective cam 6, but also only in a point-like manner or in portions over the region of the respective cam 6.

FIG. 5 shows as a further variant two filter plies 2a, 2b, which are joined to each other by means of a grooving 8. Such a groove-like geometry can be produced by a groove-like structure being provided on the two exterior circumferential sides 15a, 15b of the two rollers 13a, 13b. Such so-called grooving rolls provide for the connection of the two filter plies 2a, 2b in the region of the grooving 8. A joining connection does not necessarily have to be produced here over the entire surface, but rather only in a punctiform manner or in some areas, in particular at the vertices 9a and at the flanks 9b of the grooving 8. Hereby, a rigid and nevertheless very flow-optimized fibre ply composite is produced. The folding of the later fold star can be rotated through 90° to the grooving 8.

In a variant not illustrated in further detail in the figures, an ultrasound source can also be used as joining tool 11 alternatively to the previously explained pressing tool 12. By means of such an ultrasound source, the at least two filter plies 2a, 2b can be joined to each other by the action of ultrasound in an analogous manner to the use of a pressing tool 12 described above, and can be arranged in some areas at a distance from one another.

1-17. (canceled)

18. A method for manufacturing a filter medium comprising at least two filter plies according to which at least a first filter ply has a plurality of thermoplastically deformable fibres, by means of which the at least two filter plies are joined to each other in some areas, the method comprising:
forming, by means of at least two rolls of a pressing tool, at least one additional joining region configured in a web-like manner in the at least two filter plies in which the at least two filter plies are joined to each other.

19. The method according to claim 18, wherein the at least two filter plies have respectively at least one portion in which they are not joined to each other by means of the thermoplastically deformable fibres.

20. The method according to claim 18, further comprising one of warming the thermoplastically deformable fibres of the first filter ply before joining the at least two filter plies to each other and warming the thermoplastically deformable fibres of the first filter ply during joining the at least two filter plies to each other such that the thermoplastically deformable fibres are one of softened by the warming and at least partially melted by the warming.

21. The method according to claim 20, wherein warming the thermoplastically deformable fibres comprises warming the thermoplastically deformable fibres by means of a heating device; and
wherein the thermoplastically deformable fibres are deformed thermoplastically.

22. The method according to claim 21, wherein the heating device is part of a joining tool for joining the two filter plies to each other.

23. The method according to claim 18, wherein at least one filter ply of the at least two filter plies has additional, non-thermoplastic fibres.

24. The method according to claim 35, wherein the joining tool is configured such that a predetermined distance geometry is produced in the at least one portion in which the two filter plies are not joined to each other by means of the thermoplastically deformable fibres.

25. The method according to claim 19, further comprising joining the at least two filter plies to each other in the some areas while maintaining other areas at a distance from one another.

26. The method according to claim 25, wherein the distance comprises a distance geometry comprising one of a sinusoidal geometry, a trapezoidal geometry, and a groove-like geometry.

27. The method according to claim 22, wherein the joining tool comprises an ultrasound source configured to join the at least two filter plies to each other in the some areas by an action of ultrasound and configured to arranged other areas at a distance from one another.

28. The method according to claim 18, wherein at least a second filter ply of the at least two filter plies is provided without fibres and comprises one of a ply material cellulose and nanofibres, wherein the ply material cellulose comprises paper.

29. A filter medium manufactured according to claim 18, the filter medium comprising:
a first filter ply and at least a second filter ply, wherein at least one of the first filter ply and the at least a second filter ply has a plurality of thermoplastically deformable fibres by means of which the first filter ply and the at least a second filter ply are joined to each other in some areas.

30. The filter medium according to claim 29, wherein the first filter ply and the at least a second filter ply have respectively at least one portion in which they are not joined to each other by means of the thermoplastically deformable fibres.

31. The filter medium according to claim 30, wherein, in the at least one portion in which the first filter ply and the at least a second filter ply are not joined to each other by means of the thermoplastically deformable fibres, the the first filter ply and the at least a second filter ply have a predetermined distance geometry.

32. The filter medium according to claim 31, wherein the predetermined distance geometry is one of a sinusoidal geometry, a trapezoidal geometry, a groove-like geometry, and a cam-like geometry.

33. The method according to claim 20, wherein warming the thermoplastically deformable fibres comprises warming the thermoplastically deformable fibres by means of a heating device; and
wherein the thermoplastically deformable fibres are deformed thermoplastically.

34. The method according to claim 33, wherein the heating device is part of a joining tool for joining the two filter plies to each other.

35. The method according to claim 19, further comprising one of warming the thermoplastically deformable fibres of the first filter ply before joining the at least two filter plies to each other and warming the thermoplastically deformable fibres of the first filter ply during joining the at least two filter plies to each other such that the thermoplastically deformable fibres are one of softened by the warming and at least partially melted by the warming.

36. The method according to claim 35, wherein warming the thermoplastically deformable fibres comprises warming the thermoplastically deformable fibres by means of a heating device; and
wherein the heating device is part of a joining tool for joining the two filter plies to each other.

37. The method according to claim 36, wherein the joining tool is configured such that a predetermined distance geometry is produced in the at least one portion in which the two filter plies are not joined to each other by means of the thermoplastically deformable fibres.
